(19) United States
(12) Patent Application Publication
(10) Pub. No.: US 2026/0193735 A1
(43) Pub. Date: Jul. 9, 2026

(54) SYSTEM AND PROCESS FOR RECOVERING LITHIUM FROM A SALTWATER

(71) Applicant: SALTWORKS TECHNOLOGIES INC., Richmond (CA)

(72) Inventors: Benjamin SPARROW, Richmond (CA); Megan LOW, Richmond (CA); Xiangchun YIN, Richmond (CA)

(73) Assignee: SALTWORKS TECHNOLOGIES INC., Richmond, BC (CA)

(21) Appl. No.: 18/995,708

(22) PCT Filed: Jul. 19, 2023
(86) PCT No.: PCT/CA2023/050972

§ 371 Date: Jan. 16, 2025

Related U.S. Application Data
(60) Provisional application No. 63/390,400, filed on Jul. 19, 2022.

(51) Int. Cl. C22B 26/12; C22B 3/24; C22B 3/42; C25C 1/02; C25C 7/02

(52) U.S. Cl. CPC C22B 26/12; C22B 3/24; C22B 3/42; C25C 1/02; C25C 7/02

(57) ABSTRACT

A method and system for recovering lithium from a saltwater. Lithium in the saltwater is extracted by applying a first direct lithium extraction process to produce a first lithium recovery solution having a mass ratio of lithium content to total dissolved solids content of at least 0.01, which is then concentrated by applying reverse osmosis to produce a reverse osmosis concentrate. Lithium in the concentrated first lithium recovery solution is then extracted by applying a second direct lithium extraction process to produce a second lithium recovery solution having a mass ratio of lithium content to total dissolved solids content of at least 0.04. Battery grade lithium carbonate can be produced from the second lithium recovery solution.

### TECHNICAL FIELD

The present disclosure relates to systems, processes, and techniques for recovering lithium from a saltwater. More particularly, the present disclosure relates to systems, processes, and techniques for recovering lithium from a saltwater having a low lithium content (e.g., less than 300 mg/L) and a high impurity content (e.g., a mass ratio of lithium content to total dissolved solids content of not more than 0.005).

### BACKGROUND

Lithium is a key element of lithium-ion batteries, which are used for electric cars and power storage equipment. Although the Earth is abundant in lithium, there are relatively few lithium resources having sufficient lithium content and purity to permit cost-effective recovery using conventional technologies. Consequently, lithium is recovered primarily from high-grade lithium resources such as spodumene and salar brines, which may contain a lithium content above 2,000 mg/L. Lithium in salar brines is usually recovered using evaporative concentration in evaporation ponds.

### SUMMARY

According to a first aspect, there is provided a lithium recovery process for recovering lithium from a saltwater, the process comprising: extracting lithium from the saltwater by applying a first direct lithium extraction process to produce a first lithium recovery solution having a mass ratio of lithium content to total dissolved solids content of at least 0.01 and a first lithium-depleted brine; and extracting lithium from the first lithium recovery solution by applying a second direct lithium extraction process to produce a second lithium recovery solution having a mass ratio of lithium content to total dissolved solids content of at least 0.04 and a second lithium-depleted brine, wherein each of the first and the second direct lithium extraction processes is a selective lithium adsorption process, a selective lithium ion exchange process, or an electrochemical lithium extraction process (i.e., each of the first and the second direct lithium extraction processes may be selected from the group consisting of a selective lithium adsorption process, a selective lithium ion exchange process, or an electrochemical lithium extraction process).

The lithium recovery process may further comprise concentrating the first lithium recovery solution using reverse osmosis prior to applying the second direct lithium extraction process.

The lithium recovery process may further comprise mixing at least a portion of the second lithium-depleted brine with the saltwater prior to the first direct lithium extraction process being applied to the saltwater.

The second lithium recovery solution may have a mass ratio of lithium content to total dissolved solids content of at least 1.5 times that of the first lithium recovery solution.

The first direct lithium extraction process may be the selective lithium adsorption process and the second direct lithium extraction process may be the electrochemical lithium extraction process.

Applying the selective lithium adsorption process may comprise bringing at least one of the saltwater or the first lithium recovery solution into contact with a lithium alumina intercalate resin.

The lithium alumina intercalate resin may comprise lithium aluminum layered double hydroxide chloride.

Applying the selective lithium ion exchange process may comprise bringing at least one of the saltwater or the first lithium recovery solution into contact with at least one of manganese oxide-based or titanium oxide-based lithium ion exchange resins.

The at least one of the manganese oxide-based or titanium oxide-based lithium ion exchange resins may comprise at least one of MnO₂·0.5H₂O, H_{1.6}Mn_{1.6}O₄, H₄Mn₅O₁₂, H₂TiO₃, or H₄Ti₅O₁₂.

Applying the electrochemical lithium extraction process may comprise bringing at least one of the saltwater or the first lithium recovery solution into contact with a lithium-deintercalated electrode that comprises at least one of Li_{1.6}Mn_{1.6}O₄, Li_{1.33}Mn_{1.67}O₄, λ-MnO₂, FePO₄, LiₓMn₂O₄, or LiₓFeO₄, where 0<x<1.0.

The lithium recovery process may further comprise concentrating the second lithium recovery solution using a brine concentrator to increase the lithium content of the second lithium recovery solution to 10,000-25,000 mg/L.

The brine concentrator may be selected from the group consisting of an ultra-high pressure reverse osmosis unit operated at a pressure more than 1,200 psi, a forward osmosis unit, an osmotically assisted reverse osmosis unit, a low salt rejection reverse osmosis unit, and an evaporator.

According to another aspect, there is provided a system for recovering lithium from a saltwater, the system comprising: a first direct lithium extraction unit configured to extract lithium from the saltwater to produce a first lithium recovery solution and a first lithium-depleted brine; and a second lithium extraction unit fluidly coupled to the first direct lithium extraction unit and configured to extract lithium from the first lithium recovery solution to produce a second lithium recovery solution and a second lithium-depleted brine, wherein each of the first and the second direct lithium extraction units is a selective lithium adsorption unit, a selective lithium ion exchange unit, or an electrochemical lithium extraction unit (i.e., each of the first and the second direct lithium extraction units may be selected from the group consisting of a selective lithium adsorption unit, a selective lithium ion exchange unit, or an electrochemical lithium extraction unit).

The system may further comprise a reverse osmosis unit fluidly coupled to and downstream of the first direct lithium extraction unit and to and upstream of the second lithium direct lithium extraction unit and configured to concentrate the first lithium recovery solution prior to the first lithium recovery solution entering the second direct lithium extraction unit.

The system may further comprise a conduit fluidly coupled to an outlet of the second direct lithium extraction unit and to an inlet of the first direct lithium extraction unit such that at least a portion of the second lithium-depleted brine is mixable with the saltwater prior to the saltwater entering the first direct lithium extraction unit.

The system may further comprise a brine concentrator fluidly coupled to an outlet of the second direct lithium extraction unit to receive the second lithium recovery solution and configured to concentrate the second lithium recovery solution. The brine concentrator may be selected from the group consisting of an ultra-high pressure reverse osmosis unit operated at a pressure more than 1,200 psi, an osmotically assisted reverse osmosis unit, a low salt rejection reverse osmosis unit, and an evaporator.

The first direct lithium extraction unit may be the selective lithium adsorption unit and the second direct lithium extraction may be the electrochemical lithium extraction unit.

The selective lithium adsorption unit may comprise a lithium alumina intercalate comprising lithium aluminum layered double hydroxide chloride.

The selective lithium ion exchange unit may comprise at least one of manganese oxide-based or titanium oxide-based ion exchange resins. The at least one of the manganese oxide-based or titanium oxide-based lithium ion exchange resins may comprise at least one of MnO₂·0.5H₂O, H_{1.6}Mn_{1.6}O₄, H₄Mn₅O₁₂, H₂TiO₃, or H₄Ti₅O₁₂.

The electrochemical lithium extraction unit may comprises a lithium-deintercalated electrode that comprises at least one of Li_{1.6}Mn_{1.6}O₄, Li_{1.33}Mn_{1.67}O₄, λ-MnO₂, FePO₄, LiₓMn₂O₄, and LiₓFeO₄, where 0<x<1.0.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a schematic diagram illustrating a lithium recovery system comprising two direct lithium extraction units connected in series, according to an example embodiment.

FIG. 2 is a schematic diagram illustrating a lithium recovery system comprising a selective lithium adsorption unit and an electrochemical lithium extraction unit connected in series, according to an example embodiment.

For the sake of clarity, not every component is labeled, nor is every component of each embodiment shown where illustration is unnecessary to allow those of ordinary skill in the art to understand the embodiments described herein.

### DETAILED DESCRIPTION

While evaporative concentration may be used to recover lithium from high-grade lithium sources, it is not cost-effective or sufficiently efficient for low-grade lithium resources, which have a low lithium content (e.g., less than 300 mg/L) and a high impurity content (e.g., a mass ratio of lithium content to total dissolved solids content of not more than 0.005).

Direct lithium extraction techniques (DLEs) selectively recover lithium from a lithium-containing saltwater while leaving behind water and most of the impurities dissolved in the saltwater. DLEs, such as selective lithium adsorption, selective lithium ion exchange, and electrochemical lithium extraction, enable lithium recovery from a low-grade lithium saltwater having a lithium content less than 300 mg/L and an impurity content with a mass ratio of lithium content to total dissolved solids content (Li/TDS ratio) of not more than 0.005. It is not economical or efficient to apply evaporative concentration methods to recover lithium from such low-grade solutions.

Depending on the selectivity of DLEs for lithium over other ion impurities, the recovered lithium solution from DLEs may still contain significant amounts of impurities, which impacts the yield and the purity of downstream lithium products such as battery grade lithium carbonate and lithium hydroxide monohydrate. In at least some example embodiments disclosed herein, a lithium recovery system comprising two direct lithium extraction units connected in series is used to extract lithium from a saltwater. An intermediate product, a first lithium recovery solution, is the output of the first direct lithium extraction unit. This intermediate product is input to the second direct lithium extraction unit to further purify it, and more particularly to improve its Li/TDS ratio, prior to converting the recovered lithium into battery grade lithium carbonate or lithium hydroxide monohydrate.

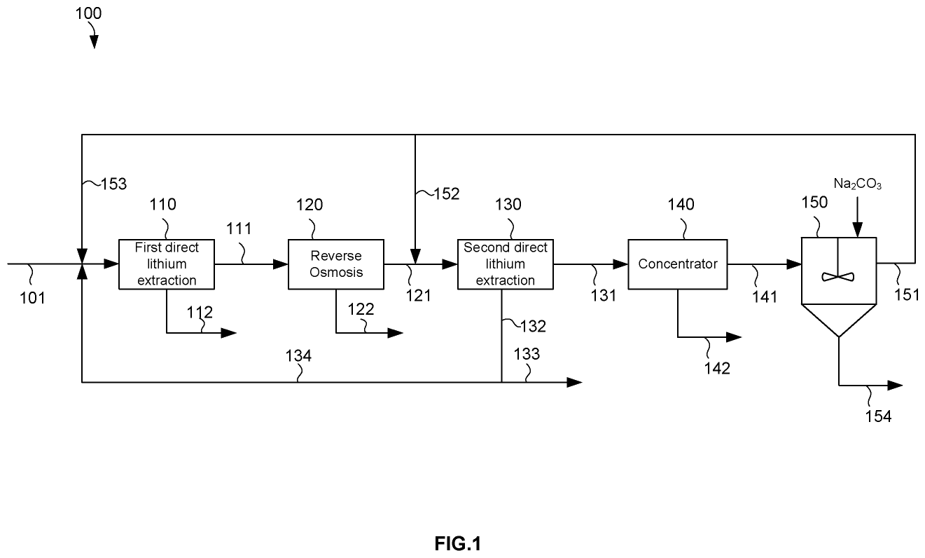

FIG. 1 illustrates, according to one example embodiment, a lithium recovery system 100 that recovers lithium from a saltwater. The system 100 comprises:
i) a first direct lithium extraction unit 110 configured to extract lithium from the saltwater to produce a first lithium recovery solution and a first lithium-depleted brine; and
ii) a second direct lithium extraction unit 130 fluidly coupled to the first direct lithium extraction unit 110 and configured to extract lithium from the first lithium recovery solution to produce a second lithium recovery solution and a second lithium-depleted brine, wherein each of the first and the second direct lithium extraction units is a selective lithium adsorption unit, a selective lithium ion exchange unit, or an electrochemical lithium extraction unit.

As shown in FIG. 1, the system 100 may further comprise a reverse osmosis unit 120 fluidly coupled to and downstream of the first direct lithium extraction unit 110 and to and upstream of the second lithium direct lithium extraction unit 130, and configured to concentrate the first lithium recovery solution prior to the first lithium recovery solution being purified by the second direct lithium extraction unit 130. FIG. 1 also shows a conduit 134 fluidly coupling an outlet of the second direct lithium extraction unit 130 to an inlet of the first direct lithium extraction unit 110; this permits at least a portion of the second lithium-depleted brine to be recycled by mixing it with the saltwater fed into the first direct lithium extraction unit 110. Also as shown in FIG. 1, a brine concentrator 140 may be fluidly coupled to and downstream of the second lithium direct lithium extraction unit 130 and be configured to concentrate the second lithium recovery solution; and a reactor 150 may be fluidly coupled to and downstream of the brine concentrator 140 and be configured to convert lithium in the second lithium recovery solution into lithium carbonate.

Various combinations of direct lithium extraction units 110, 130 and other pieces of equipment are possible in the system 100. For example, the first and second direct lithium extraction units 110, 130 may both comprise a selective lithium adsorption unit, and the reverse osmosis unit 120 may be fluidly coupled between the two units 110, 130. As another example, the first direct lithium extraction unit 110 may comprise a selective lithium adsorption unit and the second direct lithium extraction unit 130 may comprise an electrochemical lithium extraction unit, and the two units 110, 130 may be directly connected to each other (e.g., there is no reverse osmosis unit 150 fluidly coupled between them).

As noted above, each of the first and second direct lithium extraction units 110, 130 may comprise a selective lithium adsorption unit, a selective lithium ion exchange unit, or an electrochemical lithium extraction unit. Each of these different kinds of lithium extraction units 110, 130 is described in further detail below. While in at least some embodiments the first and second direct lithium extraction units 110, 130 are the same type of units, in other embodiments they may be different types of units. For example, the first direct lithium extraction unit 110 may comprise a selective lithium adsorption unit, and the second direct lithium extraction unit 130 may comprise an electrochemical lithium extraction unit.

A selective lithium adsorption unit comprises a lithium alumina sorbent resin that is put into contact with the saltwater comprising lithium and that, through that contact, adsorbs lithium from the saltwater on to the resin. Suitable lithium alumina sorbent resins include, but are not limited to, resins comprising hydrated alumina or lithium aluminum layered double hydroxide chloride. Example preparation processes of the lithium alumina sorbent resins are described, for example, in U.S. Pat. Nos. 4,348,295; 4,461,714; 6,280,693; and 8,753,594. A lithium alumina sorbent resin may be prepared through incorporating one of hydrated alumina or lithium aluminum layered double hydroxide chloride with at least one of an ion exchange resin, a zeolite or a polymeric binder. The lithium alumina sorbent resins are packed into columns or beds into which saltwater comprising lithium is pumped to facilitate selective lithium adsorptions. A continuous countercurrent adsorption and desorption process may be used when operating a selective lithium adsorption unit; an example continuous countercurrent adsorption and desorption process is described in U.S. Pat. Pub. No. 2019/0256368.

A selective lithium ion exchange unit comprises at least one of manganese oxide-based or titanium oxide-based lithium ion exchange resins. Suitable manganese oxide-based and titanium oxide-based lithium ion exchange resins include, but are not limited to, resins comprising MnO₂·0.5H₂O; H_{1.6}Mn_{1.6}O₄; H₄Mn₅O₁₂; H₂TiO₃ and H₄Ti₅O₁₂. Example preparation processes of manganese oxide-based and titanium oxide-based lithium ion exchange resins are described, for example, in U.S. Pat. Nos. 6,764,584; and 10,150,056. The manganese oxide-based resin may be prepared by incorporating manganese oxide-based compounds with a polymeric matrix, and the titanium oxide-based lithium ion exchange resin may be prepared by incorporating titanium oxide-based compounds with a polymeric matrix. At least one of the manganese oxide-based or titanium oxide-based lithium ion exchange resins are packed into columns or beds into which saltwater comprising lithium is pumped to facilitate selective lithium ion exchange. The manganese oxide-based and titanium oxide-based lithium ion exchange resins may be first prepared in a lithiated format and then be converted into a proton format through acid treatment. When the resins in proton format are contacted with a saltwater, lithium in the saltwater selectively exchanges with protons so that lithium adsorbs onto the resin and protons are released from the resin into the saltwater. A continuous countercurrent adsorption and desorption process may be used when operating a selective lithium adsorption unit; an example continuous countercurrent adsorption and desorption process is described in U.S. Pat. No. 9,771,632.

An electrochemical lithium extraction unit comprises a lithium-deintercalated electrode. Suitable lithium-deintercalated electrodes include, but are not limited to, compositions comprising at least one of Li_{1.6}Mn_{1.6}O₄, Li_{1.33}Mn_{1.67}O₄, λ-MnO₂, FePO₄, LiₓMn₂O₄, or LiₓFeO₄, where 0<x<1.0. Example electrochemical lithium extraction units that may be used for one or both of the first or second direct lithium extraction units 110, 130 are described, for example, in International Pat. Pub. Nos. WO 2014/047347; and WO 2012/065361. During electrochemical lithium extraction, the lithium-deintercalated electrode is coupled with another electrode which can absorb an anion or release a cation to form an electrochemical device. In some embodiments of electrochemical lithium extraction, both electrodes may be submerged in a solution comprising lithium, and an anion or cation exchange membrane may be positioned in the solution such that any ions originating at one the electrodes needs to pass through the membrane in order to reach the other electrode. The lithium-deintercalated electrode selectively extracts lithium from a saltwater when a potential is applied to the coupled electrodes.

The brine concentrator 140 may be selected from the group consisting of an ultra-high pressure reverse osmosis unit with an operational pressure more than 1,200 psi, a forward osmosis unit, an osmotically assisted reverse osmosis unit, a low salt rejection reverse osmosis unit, and an evaporator.

According to at least some embodiments and with reference to FIG. 1, a process for recovering lithium from a saltwater comprises:
i) extracting lithium from the saltwater by applying a first direct lithium extraction process to the saltwater to produce a first lithium recovery solution having a mass ratio of lithium content to total dissolved solids content of at least 0.01 and a first lithium-depleted brine; and
ii) extracting lithium from the first lithium recovery solution by applying a second direct lithium extraction process thereto to produce a second lithium recovery solution having a mass ratio of lithium content to total dissolved solids content of at least 0.04 and a second lithium-depleted brine,
   wherein each of the first and the second direct lithium extraction processes is a selective lithium adsorption process, a selective lithium ion exchange process, or an electrochemical lithium extraction process.

According to at least some embodiments, the process further comprises concentrating the first lithium recovery solution by applying reverse osmosis thereto prior to applying the second direct lithium extraction process to the first lithium recovery solution. This concentrating increases the lithium content and the total dissolved solids content in the first lithium recovery solution prior to the second direct lithium extraction process being applied. It has been found experimentally that this concentrating improves lithium adsorption efficiency of the second direct lithium extraction process when the second direct lithium extraction process is a selective lithium adsorption process. In at least some embodiments, the second lithium recovery solution has a mass ratio of lithium content to total dissolved solids content of at least 1.5 times than the first lithium recovery solution.

As discussed above, applying a selective lithium adsorption process may comprise bringing the saltwater or first lithium recovery solution into contact with lithium alumina sorbent resins comprising one of hydrated alumina or lithium aluminum layered double hydroxide chloride; applying a selective lithium ion exchange process may comprise bringing the saltwater or first lithium recovery solution into contact with at least one of manganese oxide-based or titanium oxide-based lithium ion exchange resins comprising at least one of MnO₂·0.5H₂O; H_{1.6}Mn_{1.6}O₄; H₄Mn₅O₁₂; H₂TiO₃ or H₄Ti₅O₁₂; and applying an electrochemical lithium extraction process may comprise bringing the saltwater or first lithium recovery solution into contact with a lithium-deintercalated electrode comprising at least one of Li_{1.6}Mn_{1.6}O₄, Li_{1.33}Mn_{1.67}O₄, λ-MnO₂, FePO₄, LiₓMn₂O₄, or LiₓFeO₄, 0<x<1.0.

During operation of the lithium recovery system 100 of FIG. 1, a saltwater is fed via conduit 101 to the system 100 and the first direct lithium extraction unit 110. The saltwater may be at least one of a salar brine, a geothermal brine, or a produced water resulting from oil/gas production, and the saltwater may have a lithium content less than 300 mg/L and an impurity content with a mass ratio of lithium content to total dissolved solids content of not more than 0.005. The saltwater may be pretreated through at least one pretreatment unit (not shown in FIG. 1), such as a gas flotation unit, a sedimentation unit, a media filter, a microfilter, or heating/cooling units. Lithium in the saltwater is extracted by the first direct lithium extraction unit 110, resulting in the first lithium recovery solution and the first lithium-depleted brine being created. The first lithium recovery solution is directed via conduit 111 to the reverse osmosis unit 120. The first lithium-depleted brine comprises water and most of the impurities in the saltwater, and is discharged via conduit 112 out of the system 100.

The reverse osmosis unit 120 concentrates the first lithium recovery solution and produces a reverse osmosis permeate, which is discharged via conduit 122 out of the system 100. Alternatively, the reverse osmosis permeate may be directed to inputs of either or both of the first and the second direct lithium extraction units 110, 130 for recycling. The concentrated first lithium recovery solution is directed via conduit 121 to the inlet of the second direct lithium extraction unit 130.

The second direct lithium extraction unit 130 performs direct lithium extraction on the first lithium recovery solution to produce the second lithium recovery solution. Relative to the first lithium recovery solution, the second lithium recovery solution has an improved (i.e., higher) mass ratio of lithium content to total dissolved solids content. The second lithium recovery solution is directed from the second direct lithium extraction unit 130 via conduit 131 to the brine concentrator 140. As a byproduct of producing the second lithium recovery solution, the second direct lithium extraction unit 130 produces a second lithium-depleted brine. This brine is discharged via conduits 132, 133 out of the system 100. In some embodiments, at least a portion of the second lithium-depleted brine is recycled via conduits 132, 134 to the inlet of the first direct lithium extraction unit 110 to be mixed with the saltwater prior to the first direct lithium extraction process being performed.

The brine concentrator 140 concentrates the second lithium recovery solution to increase its lithium concentration to about 10,000-25,000 mg/L; it has been found experimentally that when the lithium concentration of the second lithium recovery solution is within this range, recovery yield and purity of lithium recovered from the second lithium recovery solution is improved. The concentrator 140 also produces a fresh water, which is discharged via conduit 142 out of the system 100.

Lithium in the concentrated second lithium recovery solution is converted into lithium carbonate by reacting it with sodium carbonate (Na₂CO₃), which is added to and within the reactor 150. The concentrated second lithium recovery solution may be polished through an ion exchange process (not shown in FIG. 1) prior to the lithium carbonate conversion to remove at least some calcium and magnesium therefrom. Any lithium carbonate solids are discharged via conduit 152 out of the system 100. A blowdown brine is also produced during the lithium carbonate conversion in the reactor 150. The blowdown brine is rich in carbonate and can be recycled via conduits 151, 152 to be mixed with the first lithium recovery solution after it has been concentrated by the reverse osmosis unit 120 and before being input to the second direct lithium extraction unit 130, or via conduits 151,153 to be mixed with the saltwater prior to being input to the first direct lithium extraction unit 110 for hardness removal or pH adjustment.

Certain embodiments are further illustrated in the following example. It is however to be understood that these examples are for illustrative purposes only, and are not to be used to limit the scope of the present disclosure in any manner.

### EXAMPLES

### Example 1: Extracting Lithium From a Saltwater Using a Selective Lithium Adsorption Unit and an Electrochemical Lithium Extraction Unit

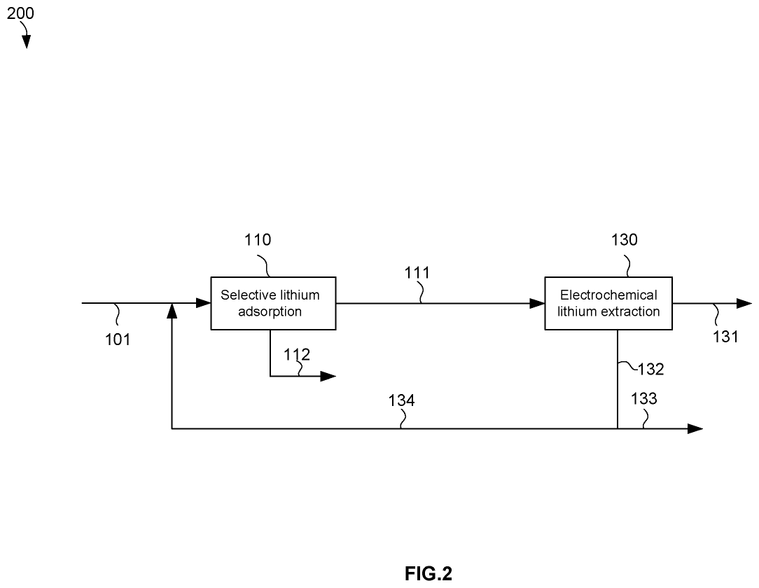

Lithium was recovered from a saltwater using a system 200 shown in FIG. 2 comprising a selective lithium adsorption unit and an electrochemical lithium extraction unit as the first direct lithium extraction unit 110 and the second direct lithium extraction unit 130, respectively. A conduit 111 connects the outlet of the first direct lithium extraction unit 110 to the inlet of the second direct lithium extraction unit 130; conduits 112, 131, and 133 are used to discharge lithium-depleted brines from the system 200; conduit 131 is used to retrieve the second lithium recovery solution from the system; and conduits 132 and 134 are used to recycle brine from the second direct lithium extraction unit 130 to the inlet of the first direct lithium extraction unit 110.

The saltwater was an aqueous solution containing 200 mg/L lithium and other ion species including calcium, magnesium, sodium, and chloride with a Li/TDS of around 0.0008. The saltwater (4.8 L) was fed at room temperature to a column packed with pretreated lithium alumina sorbent resins comprising lithium aluminum layered double hydroxide chloride (resin volume, 400 ml) for selective lithium adsorption performed by the first direct lithium extraction unit 110. The saltwater was circulated through the column from the bottom to the top at a flow rate of 8.0 BV/h for selective lithium adsorption. After one hour, the saltwater with lithium depleted therefrom, acting as a first lithium depleted brine, was drained from the column. The column was rinsed with water output from a reverse osmosis unit (not depicted in FIG. 2) (400 ml) from the top to the bottom at a flow rate of 4.0 BV/h. The water used for the rinsing was then drained from the column. The rinsed column was then eluted with water output from a reverse osmosis unit (1.8 L) from the bottom to the top at a flow rate of 4.0 BV/h to desorb lithium from the column, thereby creating the first lithium recovery solution. The first lithium recovery solution contained 452 mg/L lithium and other ion species including calcium, magnesium, sodium, and chloride with a Li/TDS of 0.031.

The first lithium recovery solution was circulated through an electrochemical stack comprising the second direct lithium extraction unit 130. The electrochemical stack comprised a lithium-deintercalated electrode comprising λ-MnO₂, an anion exchange membrane, and a lithium-intercalated electrode comprising LiMn₂O₄. Water from a reverse osmosis unit (0.5 L) was also circulated through the electrochemical stack to receive the recovered lithium, thereby resulting in the second lithium recovery solution. The electrochemical stack was operated at a potential of 0.8 V and the polarity of the applied electrical potential to the electrodes was intermittently reversed. The second lithium recovery solution contained 1,305 mg/L lithium and other ion species including calcium, magnesium, sodium, and chloride with a Li/TDS of 0.11.

The total lithium recovery (lithium mass from the second lithium recovery solution divided by lithium mass in the saltwater) was about 68%.

### Example 2: Extracting Lithium From a Saltwater Using a Selective Lithium Adsorption Unit and an Electrochemical Lithium Extraction Unit

Lithium was recovered from a saltwater using the system 200 with a process similar to that used in Example 1. A selective lithium adsorption unit was used as the first direct lithium extraction unit 110 and an electrochemical lithium extraction unit was used as the second direct lithium extraction unit 130. The saltwater contained 70 mg/L of lithium and other ion species including calcium, magnesium, sodium, and chloride with a Li/TDS mass ratio of around 0.0003. The first lithium recovery solution from the selective lithium adsorption unit contained 149 mg/L lithium, and other ion species including calcium, magnesium, sodium and chloride with a Li/TDS mass ratio of around 0.01. The second lithium recovery solution from the electrochemical lithium extraction unit contained 402 mg/L lithium and other ion species including calcium, magnesium, sodium, and chloride with a Li/TDS mass ratio of around 0.04.

The total lithium recovery was about 60%.

### Example 3: Extracting Lithium From a Saltwater Using a Selective Lithium Adsorption Unit and an Electrochemical Lithium Extraction Unit

Lithium was recovered from a saltwater using the system 200 with a process similar to Example 1. A selective lithium adsorption unit was used as the first direct lithium extraction unit 110 and an electrochemical lithium extraction unit was used as the second direct lithium extraction unit 130. The saltwater contained 40 mg/L lithium and other ion species including calcium, magnesium, sodium, and chloride with a Li/TDS mass ratio of around 0.0002. The first lithium recovery solution from the selective lithium adsorption unit contained 92 mg/L lithium, and other ion species including calcium, magnesium, sodium and chloride with a Li/TDS mass ratio of around 0.006. The second lithium recovery solution from the electrochemical lithium extraction unit contained 185 mg/L lithium and other ion species including calcium, magnesium, sodium, and chloride with a Li/TDS mass ratio of around 0.02.

The total lithium recovery was about 48%.

### Example 4: Preparation of Lithium Carbonate

The second lithium recovery solutions from Examples 1, 2, and 3 were concentrated using an evaporation process into concentrated solutions each with a lithium content of around 15,000 mg/L. The concentrated second recovery solutions of Examples 1 and 2 stayed as solutions and no crystal precipitated out. However, sodium chloride crystal precipitated out while evaporating the second lithium recovery solution of Example 3; more than 40% of the lithium from the concentrated second lithium recovery solution had been lost with the precipitated sodium chloride solids.

After removing calcium and magnesium through a chelating ion exchange process, the concentrated second recovery solutions were used to prepare lithium carbonate by reacting the solutions with sodium carbonate at 80° C. Lithium carbonate made from the concentrated second recovery lithium solutions of Example 1 and 2 were battery-grade quality after being washed 3 times with purified water output by a reverse osmosis unit. In contrast, lithium carbonate from the concentrated second recovery lithium solution of Example 3 was not battery-grade and had more than 0.5% by weight of sodium chloride contaminants even after being washed 3 times with purified water output by a reverse osmosis unit.

### Example 5: Extracting Lithium From a Saltwater Using a First Selective Lithium Adsorption Unit, a Reverse Osmosis Unit, and a Second Selective Lithium Adsorption Unit

In this example, a first selective lithium adsorption unit was the first direct lithium extraction unit 110 and a second selective lithium adsorption unit was the second direct lithium extraction unit 130. A saltwater (10 L) containing 200 mg/L of lithium and other ion species including calcium, magnesium, sodium, and chloride with a Li/TDS of around 0.0008 was treated using the first selective lithium adsorption unit. The first selected lithium adsorption unit comprised a column packed with pretreated lithium alumina sorbent resins comprising lithium aluminum layered double hydroxide chloride resin (volume, 800 ml) and was used in a similar way as Example 1 to obtain a first lithium recovery solution (3.8 L) containing 440 mg/L lithium and other ion species including calcium, magnesium, sodium, and chloride with a Li/TDS of 0.029.

When the first lithium recovery solution was fed directly to the second selective lithium adsorption unit, which similarly comprised a column packed with pretreated lithium alumina sorbent resins comprising lithium aluminum layered double hydroxide chloride resin (volume, 500 ml) and which was used in a similar way as the first selective lithium adsorption, less than 10% of the lithium in the first lithium recovery solution was extracted into the secondary lithium recovery solution. The total lithium recovery ratio was less than 8%.

To improve the lithium recovery for the second selective lithium adsorption, the first lithium recovery solution was concentrated using a reverse osmosis (RO) unit operated under 1,800 psi to produce a concentrated first lithium recovery solution with a lithium content of 2,600 mg/L. The RO-concentrated first lithium recovery solution was then fed to the second selective lithium adsorption unit as described above in the preceding paragraph. The result was that more than 90% of the lithium in the RO-concentrated first lithium recovery solution was extracted into the secondary lithium recovery solution. The total lithium recovery ratio was around 76%.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. The phrase “at least one of” when used in conjunction with a list means any one or more of any of the items of that list. For example, the phrase “at least one of A, B, or C” means A, B, C, A and B, A and C, B and C, or A and B and C.

It is contemplated that any part of any aspect or embodiment discussed in this specification can be implemented or combined with any part of any other aspect or embodiment discussed in this specification, so long as such implementation or combination is not performed using mutually exclusive parts.

One or more example embodiments have been described by way of illustration only. This description is presented for purposes of illustration and description, but is not intended to be exhaustive or limited to the form disclosed. It will be apparent to persons skilled in the art that a number of variations and modifications can be made without departing from the scope of the claims.

1. A lithium recovery process for recovering lithium from a saltwater, the process comprising:
i) extracting lithium from the saltwater by applying a first direct lithium extraction process to produce a first lithium recovery solution having a mass ratio of lithium content to total dissolved solids content of at least 0.01 and a first lithium-depleted brine; and
ii) extracting lithium from the first lithium recovery solution by applying a second direct lithium extraction process to produce a second lithium recovery solution having a mass ratio of lithium content to total dissolved solids content of at least 0.04 and a second lithium-depleted brine,
wherein each of the first and the second direct lithium extraction processes is a selective lithium adsorption process, a selective lithium ion exchange process, or an electrochemical lithium extraction process.

2. The lithium recovery process of claim 1 further comprising concentrating the first lithium recovery solution using reverse osmosis prior to applying the second direct lithium extraction process.

3. The lithium recovery process of claim 1 further comprising mixing at least a portion of the second lithium-depleted brine with the saltwater prior to the first direct lithium extraction process being applied to the saltwater.

4. The lithium recovery process of claim 1, wherein the second lithium recovery solution has a mass ratio of lithium content to total dissolved solids content of at least 1.5 times that of the first lithium recovery solution.

5. The lithium recovery process of claim 1, wherein the first direct lithium extraction process is the selective lithium adsorption process and the second direct lithium extraction process is the electrochemical lithium extraction process.

6. The lithium recovery process of claim 1, wherein applying the selective lithium adsorption process comprises bringing at least one of the saltwater or the first lithium recovery solution into contact with a lithium alumina intercalate resin.

7. The lithium recovery process of claim 6, wherein the lithium alumina intercalate resin comprises lithium aluminum layered double hydroxide chloride.

8. The lithium recovery process of claim 1, wherein applying the selective lithium ion exchange process comprises bringing at least one of the saltwater or the first lithium recovery solution into contact with at least one of manganese oxide-based or titanium oxide-based lithium ion exchange resins.

9. The lithium recovery process of claim 8, wherein the at least one of the manganese oxide-based or titanium oxide-based lithium ion exchange resins comprises at least one of MnO₂·0.5H₂O, H_{1.6}Mn_{1.6}O₄, H₄Mn₅O₁₂, H₂TiO₃, or H₄Ti₅O₁₂.

10. The lithium recovery process of claim 1, wherein applying the electrochemical lithium extraction process comprises bringing at least one of the saltwater or the first lithium recovery solution into contact with a lithium-deintercalated electrode comprising at least one of Li_{1.6}Mn_{1.6}O₄, Li_{1.33}Mn_{1.67}O₄, λ-MnO₂, FePO₄, LiₓMn₂O₄, or LiₓFeO₄, where 0<x<1.0.

11. The lithium recovery process of claim 1 further comprising concentrating the second lithium recovery solution using a brine concentrator to increase the lithium content of the second lithium recovery solution to 10,000-25,000 mg/L.

12. The lithium recovery process of claim 11, wherein the brine concentrator is selected from the group consisting of an ultra-high pressure reverse osmosis unit operated at a pressure more than 1,200 psi, a forward osmosis unit, an osmotically assisted reverse osmosis unit, a low salt rejection reverse osmosis unit, and an evaporator.

13. A system for recovering lithium from a saltwater, the system comprising:
i) a first direct lithium extraction unit configured to extract lithium from the saltwater to produce a first lithium recovery solution and a first lithium-depleted brine; and
ii) a second lithium extraction unit fluidly coupled to the first direct lithium extraction unit and configured to extract lithium from the first lithium recovery solution to produce a second lithium recovery solution and a second lithium-depleted brine,
wherein each of the first and the second direct lithium extraction units is a selective lithium adsorption unit, a selective lithium ion exchange unit, or an electrochemical lithium extraction unit.

14. The system of claim 13 further comprising a reverse osmosis unit fluidly coupled to and downstream of the first direct lithium extraction unit and to and upstream of the second lithium direct lithium extraction unit and configured to concentrate the first lithium recovery solution prior to the first lithium recovery solution entering the second direct lithium extraction unit.

15. The system of claim 13 further comprising a conduit fluidly coupled to an outlet of the second direct lithium extraction unit and to an inlet of the first direct lithium extraction unit such that at least a portion of the second lithium-depleted brine is mixable with the saltwater prior to the saltwater entering the first direct lithium extraction unit.

16. The system of claim 13 further comprising a brine concentrator fluidly coupled to an outlet of the second direct lithium extraction unit to receive the second lithium recovery solution and configured to concentrate the second lithium recovery solution, wherein the brine concentrator is selected from the group consisting of an ultra-high pressure reverse osmosis unit operated at a pressure more than 1,200 psi, an osmotically assisted reverse osmosis unit, a low salt rejection reverse osmosis unit, and an evaporator.

17. The system of claim 13, wherein the first direct lithium extraction unit is the selective lithium adsorption unit and the second direct lithium extraction is the electrochemical lithium extraction unit.

18. The system of claim 13, wherein the selective lithium adsorption unit comprises a lithium alumina intercalate comprising lithium aluminum layered double hydroxide chloride.

19. The system of claim 13, wherein the selective lithium ion exchange unit comprises at least one of manganese oxide-based or titanium oxide-based ion exchange resins, wherein the at least one of the manganese oxide-based or titanium oxide-based lithium ion exchange resins comprises at least one of MnO₂·0.5H₂O, H_{1.6}Mn_{1.6}O₄, H₄Mn₅O₁₂, H₂TiO₃, or H₄Ti₅O₁₂.

20. The system of claim 13, wherein the electrochemical lithium extraction unit comprises a lithium-deintercalated electrode comprising at least one of Li_{1.6}Mn_{1.6}O₄, Li_{1.33}Mn_{1.67}O₄, λ-MnO₂, FePO₄, LiₓMn₂O₄, or LiₓFeO₄, where 0<x<1.0.
